(19) United States
(12) Patent Application Publication
(10) Pub. No.: US 2008/0021942 A1
(43) Pub. Date: Jan. 24, 2008

(54) Arrangements for evaluating boolean functions

(75) Inventors: Alois Hahn, Vienna (AT); Robert Klima, Vienna (AT)

Correspondence Address: Alan Carlson, 6202 Lynn Lane, Lago Vista, TX, 78645, US

(73) Assignee: On Demand Microelectronics

(21) Appl. No.: 11/880,042

(22) Filed: Jul. 19, 2007

Related U.S. Application Data
(60) Provisional application No. 60/807,830, filed on Jul. 20, 2006.

(51) Int. Cl. G06F 7/38

(52) U.S. Cl. 708/209; 708/235

(57) ABSTRACT

In some embodiments a flexible scalable Boolean processing apparatus is disclosed. The apparatus can include a register to accept Boolean inputs, a Boolean lookup table coupled to the register to accept the Boolean inputs and to perform a Boolean function on the Boolean inputs and to produce a result. The apparatus can also include a multiplexer to select an executable instruction to process the result in response to an instruction select signal. In some embodiments the apparatus can include a shifter module to shift the result to a predetermined bit location in a register and a filler module to fill the register if a result has fewer bits than a number of bits required to fill the register. Other embodiments are also disclosed.

### FIELD

This document relates to arrangements for processing Boolean functions.

### BACKGROUND

Many modern processors have an “arithmetical and logical unit” (ALU). An ALU can form the “heart” of a processor and can provide a collection of processing functions. These functions can be executed in accordance with an instruction set for the processor. Each function can be activated with a different instruction word, when the instruction words are loaded from a memory into the ALU. In other words, a function to be performed can be selected with an instruction word acting as an instruction selector.

A function that is executed by an ALU can utilize input values to compute or provide respective output values or results. These input values can be taken from registers, memories, “immediate values”, or from other locations. Immediate values, generally, can be considered as constant values which can be provided as part of an instruction word. The output values or results of an execution can be stored in registers, memories, and can be sent to downstream components.

In order to achieve higher computational speeds, it is desired to reduce the number of executions that a processor has to perform to complete a process or execute a function. Hence, one important goal in designing processors is to create a processor that can complete important or repetitive tasks with a minimum of clock cycles. It is desirable to complete an instruction or function every clock cycle.

Processors often provide a number of logical instructions which can compute Boolean functions. Boolean functions can include an arbitrary number of Boolean input values combined with logical functions such as “not”, “and”, “or”, or “xor.” In some cases, the result of a Boolean function can be a Boolean value, where the Boolean value can be either a one or a zero or a true or false condition.

Boolean functions can also be a sequence of logical functions. When a sequence of instructions is required to execute a Boolean function even specialized processors may require several clock cycles to complete the execution of the Boolean function. Generally, the number of cycles required to calculate the result of a Boolean function is one cycle, multiplied by the number of logical instructions.

A couple of “mathematical” approaches are available today which can be utilized to reduce the number of clock cycles or logical operations required to process Boolean functions. This optimized Boolean function approach is similar to the non-optimized Boolean function, however, it can achieve a task with a reduced number of logical functions. Such approaches or such reductions can only be applied before or during the compile time and thus are not dynamic and configurable.

### SUMMARY

In some embodiments arrangements that can determine results of arbitrary digital functions within a single clock cycle are disclosed. The arrangements can accept an arbitrary number of input values and produce one to many output values as a result. The arrangements can utilize a configurable look-up table (that dictates the Boolean functions). The table can be dynamically altered by loading and re-loading the table. The results of a certain Boolean function can be mapped to, or correspond to the input values. Once the table is loaded, the Boolean function which has originally contained an arbitrary number of logical functions can be evaluated within a single clock cycle.

In some embodiments, a flexible scalable Boolean processing apparatus is disclosed. The apparatus can include a register to accept Boolean inputs, a Boolean lookup table coupled to the register to accept the Boolean inputs and to perform a Boolean function on the Boolean inputs and to produce a result. The apparatus can also include a multiplexer to select an executable instruction to process the result in response to an instruction select signal. In some embodiments the apparatus can include a shifter module to shift the result to a predetermined bit location in a register and a filler module to fill the register if a result has less bits than a number of bits required to fill the register.

In other embodiments a method is disclosed that includes receiving Boolean values from at least one source, selecting a Boolean function to process the Boolean values, processing the Boolean values utilizing the Boolean function wherein the processing produces a result, and selecting an instruction to process the result. The result can then be processed with the selected instruction.

### BRIEF DESCRIPTION OF THE DRAWINGS

In the following the disclosure is explained in further detail with the use of preferred embodiments, which shall not limit the scope of the invention.

FIG. 1 is a block diagram of a system for executing a Boolean function;

FIG. 2 is a block diagram of a system for executing multiple Boolean functions with programmable look-up tables;

FIG. 3 is a block diagram of a system for executing multiple Boolean functions;

FIG. 4 is a block diagram of a system for executing a Boolean function for minimum values using nibbles;

FIG. 5 is a block diagram of a system for executing Boolean functions where the input is provided from different registers;

FIG. 6 is a block diagram of a system for executing Boolean functions where the system utilizes a branch control unit; and

FIG. 7 is a block diagram of a programmable look-up table.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In some embodiments a system is disclosed which allows a processor to determine a result of a complex binary function or a Boolean function in a single clock cycle. Boolean functions can be defined as combining Boolean values (a logic high and a logic low) with logical functions such as “not”, “and”, “or”, or “xor” to produce a result. In these embodiments, Boolean functions can have an arbitrary number of input values and can have an arbitrary number of logical functions to process the input values.

A Boolean function can be represented or embodied as a “truth-table” or a look up table because a set of input values can correspond to an output value or a set of output values. Thus received inputs can be mapped to, or correspond to, a result or an output. Accordingly, a truth-table can assign each combination of possible input values to a result of the Boolean function that the table represents. A processor performing a Boolean function can store the result of the Boolean function for each combination of input values. This approach can be extended in such a way that the truth-table can provide a result based on an input that is a non-Boolean result (i.e. not a logic high and a logic low) but, for example has variables or values of a different type such as integers or a set of m Boolean output values.

A look-up table can be viewed as a mechanism which can assign an output value or a fixed number of output values to a combination of input values. The disclosed arrangements can utilize configurable and selectable look-up tables that map input values to results or correlate input values to output value(s). Such a configuration can provide selectable Boolean functions for combinations of Boolean input values. Once the tables are loaded, Boolean functions can be evaluated within a single clock cycle as the inputs are processed by the selected function. Boolean look-up tables can be queried, loaded, combined, and utilized to determine branch conditions for conditional jumps with appropriate hardware and software.

In some embodiments, the Boolean look-up tables disclosed can assign possible combination of input values to a single-bit Boolean output value. Alternately, a specialized look-up table such as a programmable look-up table can allow executable instructions to change the table's assignment or mapping of input values to output values. For example, a combination of input values can be mapped to a first set of output values during a first clock cycle and can be mapped to a single integer or a Boolean value during a second clock cycle based on the look-up tale that is selected. Such a configuration avoids the retrieval and loading of Boolean instruction during clock cycles just prior to executing the function and this can save considerable time regarding clock cycles required to execute the Boolean function.

It can be appreciated that a Boolean value provided as a result can be stored in the table as a single bit, whereas the value zero or logic low means false and a logic high or the value of one means true. To store m Boolean output values can require m bits or m data cells. Thus, a memory block using k address-bits and storing two to the power of k (i.e. 2^{k}) single-bit values could be utilized to implement at least a portion of a programmable Boolean look-up table. Generally, since a one-bit memory cell can store single-bit Boolean values the k address bits can be interpreted as k independent and different Boolean values.

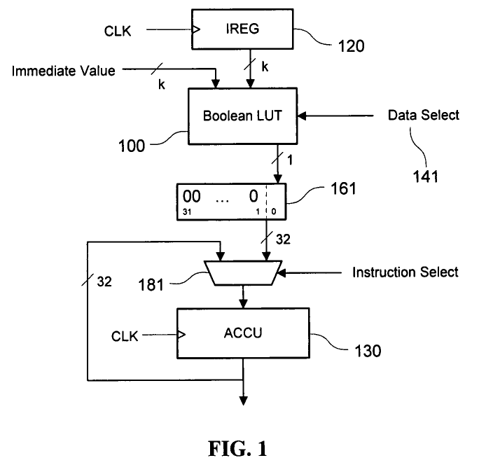

Referring to FIG. 1 a block diagram of a system that can process Boolean functions via a look-up table type process is disclosed. The system can include an internal register 120, a Boolean look up table 100, an alignment/filler module 161, a multiplexer 181, and an output register 130. Generally, the system can function in part as a Boolean look-up table where there is a relationship between input signals and the output signal(s) based on the programming in the table 100. It can be appreciated that the table functions utilized as well as instructions can be dynamically configured during system operation as different tables can be loaded and later selected to perform a function with a minimal of clock cycles.

In some embodiments, instructions and table functions can be altered every clock cycle and in other embodiments it may take several clock cycles to re-configure or re-load new or different table functions or instructions. The table 100 can receive a set of k single-bit Boolean input values from different sources such as from an internal register 120 or from a k-bit immediate values provided in the instruction word of the processor instruction. A data-selector signal 141 can be used to choose between these and/or other sources.

The look-up table 100 can return the single-bit Boolean value assigned to the combination of k single-bit input values and can pass the single bit Boolean value to an alignment/filler module 161. When output provided by the table 100 is less than 32 bits wide, alignment/filler module 161 can place the Boolean value (possibly a single bit) in a predetermined bit location in the register. For example, the result can be right justified or left justified and in some embodiments the least significant bit of the result can be placed in the least significant bit location of the register (i.e. to bit location on one side of the register). In other embodiments, the result can be placed in a predetermined or designated bit location(s) of the register such that the output bit segment of the module 161 has a predetermined width or a predetermined number of bits. For example, when a 32 bit bus is utilized module 161 can arrange or move the single-bit result provided by the look-up table 100 to the least significant bit of its 32 output bits and can set the other 31 bits to zero to fill the width of the register.

In some embodiments, multiplexer 181 can be controlled by an instruction selection line and can be controlled such that it can select different instructions, possibly each clock cycle. Thus, multiplexer 181 can elect a new instruction for evaluating results that are Boolean functions based on the instruction select input. The Boolean value processed by module 161 can then be stored in the accumulator register 130. It can be appreciated that a Boolean function of an arbitrary complexity with k Boolean input values can be evaluated within a single clock cycle utilizing the disclosed configuration. In some embodiments, k can be made reasonably small because a Boolean look-up table can require 2ₖ bits of storage. Hence, for higher values of k, a larger memory may be required and also several clock cycles may be required to upload the table.

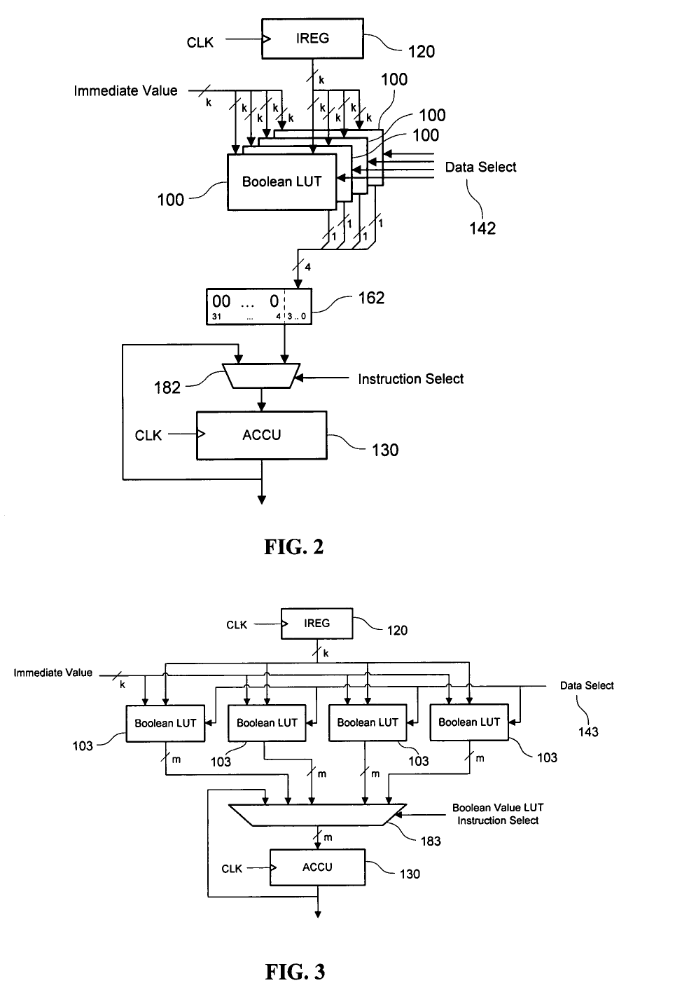

Referring to FIG. 2, a more detailed Boolean look up table configuration is illustrated, where a multitude of Boolean look-up tables 100 can be configured in a parallel relationship such that many functions can be executed concurrently. Although not limiting to the disclosed concepts, only four look-up tables 100 are illustrated as any number could be utilized. Each look-up table 100 can accept a set of k single-bit Boolean input values from different sources, possibly from one of two different sources, an internal register 120 or from a k-bit immediate value provided in the instruction word. Data-selector signal 142 can provide signals that initiate a selection between these two sources for each look-up table 100.

The look-up tables 100 can return single-bit Boolean values associated with the input, based on the selected table. These single bit values can be forwarded to shift module 162. The module 162 can convert the k-bit result of the module 100 to a specific width by justifying the result and filling un-user register locations and can transmit the result to succeeding registers. For example, when a four bit result (four single Boolean results) are provided by the table, module 162 can arrange the results as bits with bit locations in the register as bits 0 to 3 and can set the other 28 bits (4-27) to zero by providing logical zeros filler. Similar to the operation described in FIG. 1, multiplexer 182 can switch according to the signal provided by instruction select thereby selecting an instruction for evaluating results.

This output can then be stored in the accumulator register 130. It can be appreciated that in a single clock cycle, a multitude of Boolean functions can be evaluated in parallel, via the parallel Boolean look up tables as each table can concurrently process a Boolean function. It can also be appreciated that an arbitrary number of Boolean look-up tables can evaluate inputs in parallel and the number of tables activated or utilized may vary depending on instructions provided to the processor. In a four table system, four Boolean functions can be evaluated in parallel, and the four Boolean results can be stored in bits 0 to 3 in the accumulator 130 while bits 4-28 can be filled with zeros.

Referring to FIG. 3 another embodiment of a reduced overhead Boolean processing system is provided. The system can include a multitude of look-up tables 103 connected in a parallel configuration (four look-up tables 103) where each look-up table 103 may take a set of k-bit input values from multiple sources. For example the inputs may come from two different sources such as an internal register 120 or from a k-bit immediate value provided from an instruction word. Data-selectors 143 can allow for each look-up table 103 to choose between these two input sources.

The look-up tables 103 can return or output m-bit values which may be assigned to the k-bit input values in look-up tables 103. Four m-bit input values can be are returned by the look-up tables 103 and may be passed to multiplexer 183 which can, responsive to an instruction selection mechanism, choose between the m-bit results of the look-up tables 103. It can be appreciated that an output or result that depends on a Boolean function can be determined quickly within a single clock cycle when an instruction selection system is implemented.

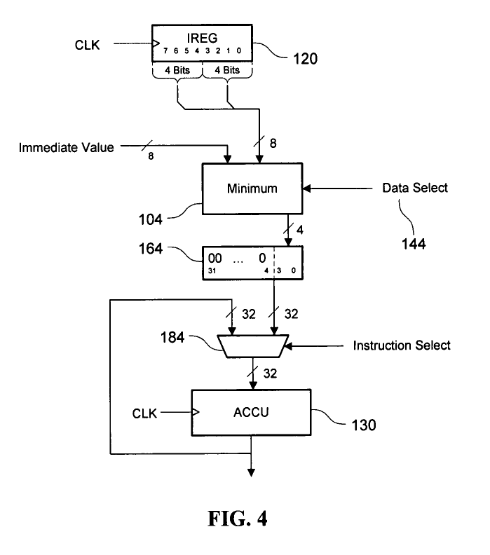

Referring to FIG. 4 a block diagram of components that can function as part of a video processing system is disclosed. The system can include internal register 120, Boolean look up table 104, justifying/filling module 164, multiplexer 184, and accumulator register 130. In operation, data can be clocked into and out of internal register 120 and can be communicated to Boolean look-up tables 104. In some embodiments, Boolean look-up table 104 can take a set of 8-bit Boolean input values from one of many sources, such as from internal register 120 or from an 8-bit immediate value provided as part of the instruction word.

A data-selector signal 144 can be utilized to choose between a plurality or multitude of input sources. The 8-bit input values can be divided into two nibbles (two four-bit values). For each combination of possible nibbles, the look-up table 104 may choose and store the nibble with the smaller value. In this embodiment, the look-up table 104 can pass a 4-bit value which is the minimum of both nibbles to a justification/filler module 164. Filler module 164 can convert the 4-bit nibble into a 32-bit wide bit segment by justifying the four bits and filling the remaining 28 bits such that the downstream components receive robust data.

Accordingly, filler module 162 can receive the output of look-up table 104 into a register as bits with numbers zero to three and set the other 28 bits to zero. Multiplexer 184 can operate as an instruction selection mechanism and select instruction for processing the output of the filler module 162 responsive to an instruction select control signal. The instruction selected can evaluate the outputs of the Boolean function table 104. According to the instruction selected, the output of module 164 can be stored in an accumulator register 130. Thus, some embodiments can have a flexible implementation by using dynamically selectable tables with dynamically selectable instructions where the tables 104 can be single- or multi-bit tables.

Referring to FIG. 5 another processing system is illustrated. The system can include a set of internal registers 125, OR gates 175, look up tables 105, multiplexer 185, filler module 165 and registers 130. The system can receive k single-bit input values in registers 125 and can OR the input values via OR gates 175 and can forward the OR'ed values to look-up tables 105. Each of the registers 125 can hold a 32-bit value that can be interpreted as the Boolean value. As stated above, the Boolean values can be “false” represented by a logical zero and a “true” represented by a non-zero value or a logical one.

The 32-bit values provided by the internal registers 125 can be reduced to a single-bit Boolean values by OR gates 175 to be processed by the look-up tables 105. Input values can be checked for non-zero values utilizing the 32-bit “OR” gates 175. Accordingly, the OR gates 175 can deliver zero on their outputs in the case where all 32 bits provided by a register 125 are zero. Thus, OR gates can be utilized to detect non zero values. Results for Boolean functions can be determined by the look-up table 105 where the results or output can be expanded to 32 bits using the justification/filler module 165. The expanded results can be stored in accumulator registers 130.

The system illustrated can execute very large instruction words (VLIW). A typical VLIW processor architecture can utilize instruction pipelines which normally comprise at least an instruction fetch stage, which loads the instructions from the memory, an instruction decode stage which decodes the loaded instructions, and an execution stage which executes the decoded instructions (all not shown). However, some processors can have shorter and longer pipelines. Conditional jumps can be a complex issue for instruction pipelines as a jump instruction can require the pipeline to be emptied and refilled resulting in processing delays and consequently in decreased of performance. The illustrated Boolean functions can determine the existence of a jump when it is loaded in the pipeline.

A conditional jump can be understood as a branch in the flow of execution of instructions that depends on a condition being met or not met. Conditional jumps may be performed if the processor evaluates and determines that a condition is met. Conditional jumps sometimes can be predicted, but in case of complex conditions a prediction that a jump is going to occur can be difficult to anticipate. Complex conditions can require several logical instructions to be processed by the execution stage.

If the condition that could not be predicted is met, the instruction pipeline often needs to be “re-filled” with a new or different set of instructions. This reload may require retrieving instructions from a “new” program address. Such filling of the instruction pipeline can take several cycles, depending on the length of the pipeline and the availability or accessibility of the data and instructions. Therefore, it can be appreciated that the disclosed systems can efficiently and quickly determine the existence of a branch. The earlier a branch can be predicted, the fewer stages of the instruction pipeline have to wait to be refilled and thus the more efficient a processing system can operate.

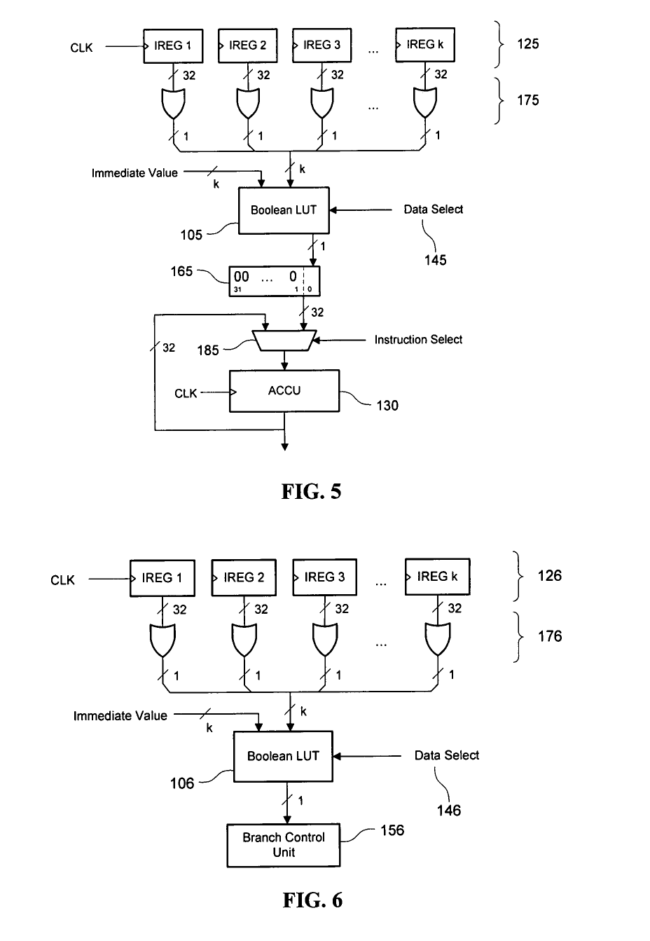

Referring to FIG. 6, Boolean processing embodiments are disclosed that can effectively execute conditional jumps. The system can include internal registers 126, OR gates 176, Boolean look up tables 106, and branch control unit 156. The registers 126 can provide Boolean input values to the OR gates 176 and the OR gates 176 can provide data to the tables 106. The look-up tables 106 can store Boolean functions that can return results that have conditional jumps based on the input to the tables 106. The results of the Boolean function provided by look-up table 106 can be passed to a branch control unit 156. Branch control unit 156 can determine if a conditional jump needs to be performed and can monitor and control other components based on this determination. In some embodiments the look-up table 106 can be designed to allow asynchronous queries to the table. If the look-up table takes a small number k of single-bit values, a look-up table containing 2^{k} values can be small and can support a fast table look-up. Hence, the system can provide evaluation of complex conditions of conditional jumps in a decoder stage and save the system many clock cycles in the event that a jump occurs.

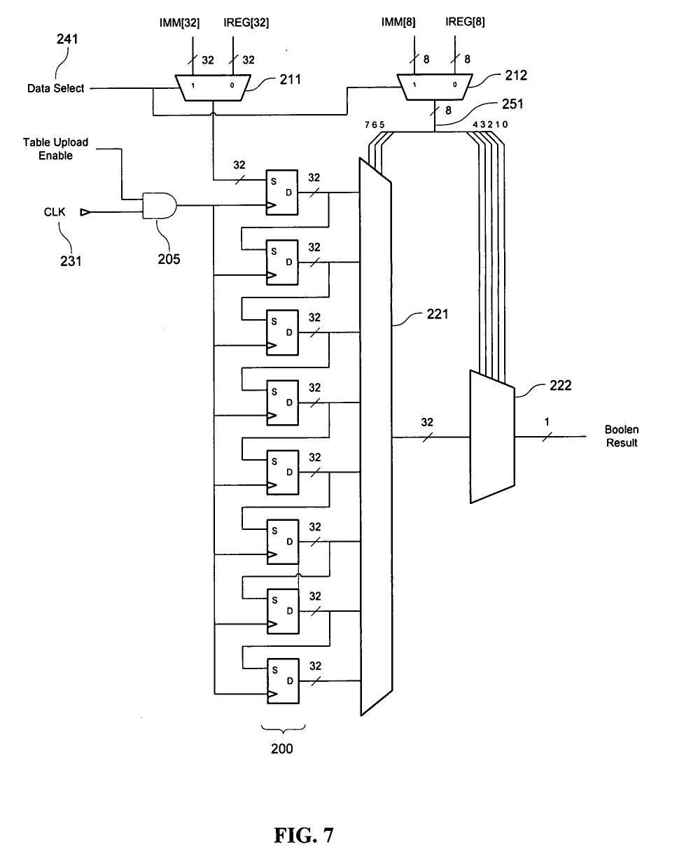

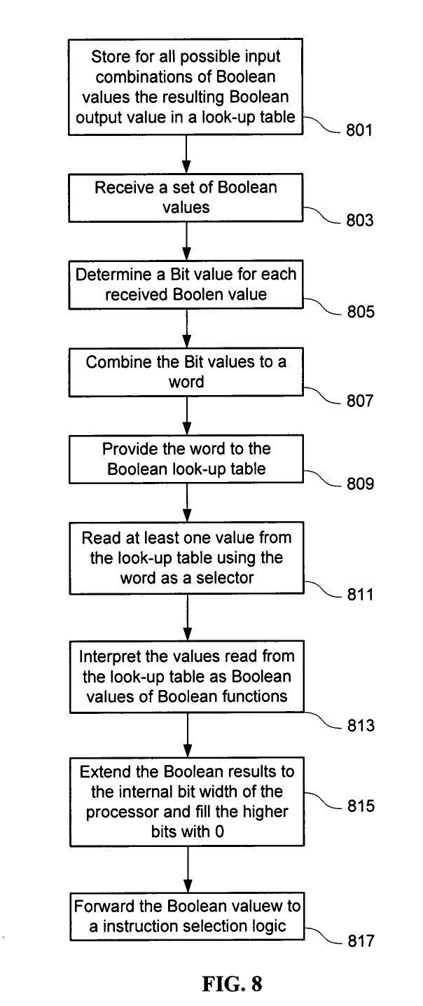

Referring to FIG. 7 a look-up table type apparatus that can store single-bit values is disclosed. The apparatus can include eight memory cells 200, AND gate 205, multiplexer 211, multiplexer 212 and multiplexer 222. The apparatus can be operated in different modes, for example a query mode and an upload mode. In a query mode, the apparatus can query the memory cells 200 using a combination of single-bit input values. In the query mode, the clock signal 231 can be disabled by setting the “table upload enable” signal to zero where an upload control module such as AND-gate 205 can isolate the memory cells 200 from the clock signal 231.

Each memory cell 200 can store 32 bits resulting in a total of 2⁸ or 256 bits that can be stored, however size should not be viewed as a limiting factor. Data selector signal on line 241 can be utilized to switch the input of the memory cells 200 between two different sources of 8-bit input values using the multiplexer 212. Three bits of the input values 251 can be taken to select one of the 32-bit values of the memory cells 200 using the multiplexer 221. The other five bits of the input values 251 can be utilized to select one value out of 32 bit outputs via multiplexer 221. The output value provided by multiplexer 222 can be the result stored in the memory cells 200 of the look-up table apparatus for the given combination of input values 251.

In an upload mode, truth-table values or values can be loaded into the memory cells 200. As described above, the loaded values can dictate the apparatus output or return of results for a given combinations of input values. In the upload mode, the “table upload enable” signal can be set to a logic high or a logical “one” to connect clock signal 231 to memory cells 200 via AND-gate 205. Data selector 241 can be utilized to switch between two different input sources of 32-bit input values via multiplexer 211.

Memory cells 200 can be arranged as 32-bit word shift registers. Accordingly, with each clock cycle each 32-bit memory cell can pass its 32-bit value to the succeeding 32-bit memory cell whereas the first memory cell of the memory cells 200 can receive its value directly from the multiplexer 211. It can be appreciated that the eight 32-bit memory cells 200 of the apparatus can be loaded in entirety in eight clock cycles. However, the architecture should not be viewed as limiting as the apparatus could be scaled or reduced without parting from the scope of the present disclosure.

Referring to FIG. 8 a method to evaluate Boolean functions using a look-up table type apparatus is disclosed. As illustrated by block 801, for possible input combinations of Boolean values of a certain Boolean function the resulting Boolean output values can be stored in a Boolean look-up table. The Boolean look-up table may not store Boolean results for Boolean input values that will never be provided. As illustrated by block 803, a set of Boolean input values can be received.

For each received Boolean input value, a single bit value can be determined, as illustrated by block 805. As illustrated by block 807, the so determined bit values can be combined to form a multi-bit segment such as a nibble or a word or a multiple thereof. The bit segment can be provided to the Boolean lookup-table as input, as illustrated by block 809. As illustrated by block 811, at least one result can be read from the Boolean look-up table for the word provided. The results can be interpreted as Boolean values which are the results of Boolean functions, as illustrated by block 813. As illustrated by block 815, the Boolean results can be extended to the internal bit width of the processor by filling the higher bits with 0. The Boolean values can be forwarded to instruction selection logic for further processing in a processing unit, as illustrated by block 817.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The modules can retrieve instructions and/or data from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can automatically tune a transmission line. It is understood that the form of the arrangements shown and described in the detailed description and the drawings are to be taken merely as examples. It is intended that the following claims be interpreted broadly to embrace all the variations of the example embodiments disclosed.

What is claimed is:

1. An apparatus comprising;
a register to accept Boolean inputs,
a plurality of Boolean lookup table coupled to the register to accept a plurality of Boolean inputs concurrently and to perform a Boolean function on the Boolean inputs and to produce at least one result; and
a multiplexer coupled to the look-up table to provide a selected executable instruction to process the result in response to an instruction select signal.

2. The apparatus of claim 1, further comprising a shifter module to shift the result to a predetermined bit location in a register.

3. The apparatus of claim 1, further comprising a filler module to fill a register if the result has less bits than a number of bits required to fill the register.

4. The apparatus of claim 1, further comprising a data select module to select a Boolean function from a plurality of Boolean functions.

5. The apparatus of claim 1, further comprising an accumulation register to store the at least one result.

6. The apparatus of claim 1, further comprising a table upload control module to facilitate uploading of table look up data to the Boolean look up table.

7. The apparatus of claim 1, further comprising a plurality of OR gates coupled to the input registers and the Boolean look up table.

8. The apparatus of claim 1, further comprising a branch control unit to receive results of the Boolean look up table and to determine a branch condition.

9. A method comprising:
receiving Boolean values from at least one source;
selecting a Boolean function to process the Boolean values;
processing the Boolean values utilizing a look-up table that represents the Boolean function wherein the processing produces at least one result; and
selecting an instruction to process the at least one result.

10. The method of claim 9, further comprising processing the at least one result with the selected instruction.

11. The method of claim 9, further comprising justifying the at least one result in a register; and
filling unused bits locations in the register.

12. The method of claim 9, wherein the result provides a conditional jump indicator to a decoder stage.

13. The method of claim 9, further comprising asynchronously querying the Boolean look up tables with a plurality of sources.

14. The method of claim 9, further comprising re-loading a Boolean lookup table to adjust the Boolean functions based on changing needs of a system.

15. The method of claim 9, further comprising selecting instructions to adjust a processing of the at least one result.

16. A computer program product comprising a computer useable medium having a computer readable program, wherein the computer readable program when executed on a computer causes the computer to:
receive Boolean values from at least one source;
select a Boolean function to process the Boolean values;
process the Boolean values utilizing the Boolean function wherein the processing produces at least one result; and
select an instruction to process the at least one result.

17. The computer program product of claim 16, further comprising a computer readable program when executed on a computer causes the computer to process the at least one result with the selected instruction.

18. The computer program product of claim 16, further comprising a computer readable program when executed on a computer causes the computer to detect a jump condition.

19. The computer program product of claim 16, further comprising a computer readable program when executed on a computer causes the computer to load a truth-table with Boolean functions.

20. The computer program product of claim 16, further comprising a computer readable program when executed on a computer causes the computer asynchronously access the Boolean function.
